(19) United States
(12) Patent Application Publication
(10) Pub. No.: US 2025/0364765 A1
(43) Pub. Date: Nov. 27, 2025

(54) METHOD AND SYSTEM FOR MAKING ULTRASHORT LIGHT SOURCES

(71) Applicant: INSTITUT NATIONAL DE LA RECHERCHE SCIENTIFIQUE, Québec (CA)

(72) Inventors: Mayank KUMAR, Longueuil (CA); Heide IBRAHIM, Montreal (CA); François LÉGARÉ, Saint-Eustache (CA); Stephen LONDO, Montreal (CA); Michael SPANNER, North Bay (CA); Marie OUILLÉ, Montreal (CA)

(21) Appl. No.: 19/218,481

(22) Filed: May 26, 2025

Related U.S. Application Data
(60) Provisional application No. 63/652,091, filed on May 27, 2024.

(51) Int. Cl. H01S 3/00; H01S 3/10; H01S 3/108

(52) U.S. Cl. CPC H01S 3/0057; H01S 3/0078; H01S 3/10092; H01S 3/1083; H01S 3/1086

(57) ABSTRACT

A method and a system for making ultrashort light sources, using a pulsed driving laser, a nonlinear medium; a hollow waveguide filed with the nonlinear medium; an input power control selected according to a central wavelength of the driving laser to control an input pulse energy from the driving laser in the hollow waveguide, a duration of the input pulse of the driving laser being selected according to a dephasing time of a molecular vibration of the nonlinear medium, the input pulse driving vibrational stimulated Raman Scattering in the nonlinear medium-filled hollow waveguide; interaction of the input pulses with the nonlinear medium in the hollow waveguide resulting as output in anti-Stokes and Stokes pulses.

### CROSS REFERENCE TO RELATED APPLICATIONS

This application claims benefit of U.S. provisional application Ser. No. 63/652,091, filed on May 27, 2024. All documents above are incorporated herein in their entirety by reference.

### FIELD OF THE INVENTION

The present invention relates to ultrashort light sources. More specifically, the present invention is concerned with a method and a system for making ultrashort light sources.

### BACKGROUND OF THE INVENTION

Most commonly used sources to generate ultrashort pulses are based on solid-state laser technologies with Titanium-Sapphire (Ti:Sa) and Ytterbium: YAG (Yb:YAG) as the gain medium. A number of methods have been presented to shift the frequency of such lasers and generate even shorter pulses than the input pulses produced by a pump laser. over a wide spectral range. These methods comprise, for example, using multistage optical parametric devices such as optical parametric amplifiers (OPAs), noncollinear optical parametric amplifiers (NOPAs), or optical parametric chirped pulse amplifiers (OPCPAs) based on the second order (χ (2) nonlinearity; or using hydrogen-filled gas cells or hollow capillaries solutions based on either stimulated Raman Scattering (SRS) or soliton red-shifting such as hollow-core photonic crystal fibers. These methods and systems are either expensive or require the use of two temporally delayed pulses or very high gas pressure, which not only bears a safety risk but also makes it impractical to design a commercial product. Additionally, the often-desired carrier envelope phase (CEP) stabilization further adds complexity to the systems since it often requires multiple stages of nonlinear processes. Achieving CEP stability of mid-infrared (MIR) pulses still requires complex setups in the case mentioned hereinabove.

There is still a need in the art for a method and a system for making ultrashort light sources.

The present description refers to a number of documents, the content of which is herein incorporated by reference in their entirety.

### SUMMARY OF THE INVENTION

More specifically, in accordance with the present invention, there is provided a system for making ultrashort light sources, comprising a pulsed driving laser, a nonlinear medium; a hollow waveguide filed with the nonlinear medium; an input power control selected according to a central wavelength of the driving laser to control an input pulse energy from the driving laser in the hollow waveguide, wherein a duration of the input pulse of the driving laser is selected according to a dephasing time of a molecular vibration of the nonlinear medium, the input pulse driving vibrational stimulated Raman Scattering in the nonlinear medium-filled hollow waveguide; interaction of the input pulses with the nonlinear medium in the hollow waveguide resulting as output in anti-Stokes and Stokes pulses.

There is further provided a method comprising passing an input pulse from a pulsed driving laser into a Raman-active medium-filled hollow waveguide to generate frequency-shifted Stokes output by stimulated Raman scattering, resulting in frequency-shifted Stokes output pulses of a wavelength depending upon a wavelength of the driving laser and a Raman shift produced by the Raman-active medium.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

In the appended drawings:

FIG. 1 is a schematical view of a system according to an embodiment of an aspect of the present disclosure;

FIG. 2 is a schematical view of a system according to an embodiment of an aspect of the present disclosure;

FIG. 3 is a schematical view of a system according to an embodiment of an aspect of the present disclosure;

FIG. 4 is a schematical view of a system according to an embodiment of an aspect of the present disclosure;

FIG. 5 is a schematical view of a system used in experiments according to an embodiment of an aspect of the present disclosure;

FIG. 6A shows experimental frequency-resolved optical gating (FROG) trace; FIG. 6B shows reconstructed FROG trace; FIG. 6C shows retrieved temporal profile; and FIG. 6D shows experimental and retrieved spectral profiles; in characterization tests of near infrared (NIR) SRS pulse (input—1.06 ps, 1030 nm, 2 W (2 mJ/pulse at 1 KHz), with the hollow-core fiber (HCF) at a static methane pressure of 2 bar, and spectrally filtering the SRS pulses from the residual input pulses at the HCF output, characterized using second-harmonic generation frequency-resolved optical gating (SHG-FROG), according to an embodiment of an aspect of the present disclosure;

FIG. 7A shows experimental FROG trace; FIG. 7B shows reconstructed FROG trace; FIG. 7C shows retrieved temporal profile; and FIG. 7D shows experimental and retrieved spectral profiles; in characterization tests of NIR SRS Pulse (input—4.7 ps, 1030 nm, 2 W (2 mJ/pulse at 1 KHz)), with the HCF at a static methane pressure of 2 bar, and spectrally filtering the SRS pulses from the residual input pulses at the HCF output, characterized using SHG-FROG according to an embodiment of an aspect of the present disclosure;

FIG. 8A shows Table 1 of photon conversion efficiency from pump (1030 nm) to generated SRS pulses centered at about 1475 nm for 2 W input, according to an embodiment of an aspect of the present disclosure; and

FIG. 8B shows Table 2 of the factor of temporal compression for SRS pulses with respect to input pump pulses, according to an embodiment of an aspect of the present disclosure.

### DESCRIPTION OF ILLUSTRATIVE EMBODIMENTS

The present invention is illustrated in further detail by the following non-limiting examples.

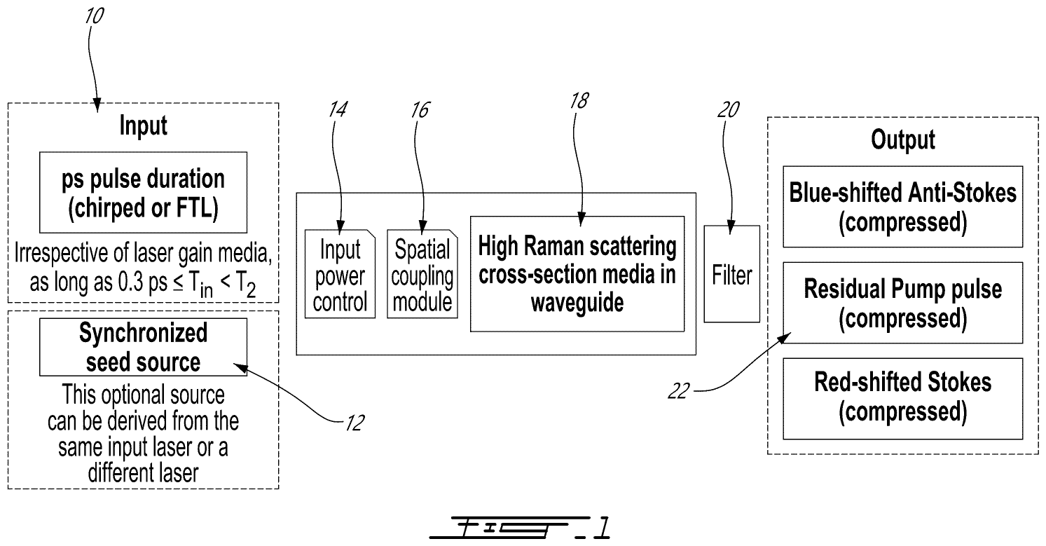

A system according to an embodiment of an aspect of the present invention as illustrated in FIG. 1 uses vibrational stimulated Raman Scattering (SRS) for compression and frequency-shifting of sub-ps to ps pulses, irrespective of the laser gain medium and the emission wavelength, to the fs regime and for different pump sources operating in different spectral ranges where the input pulse duration (Tᵢₙ) of a pulsed driving laser used as the pump laser is shorter than the molecular vibration dephasing time (T₂) of a Raman-active medium. A synchronized seed pulse may be used to improve the conversion efficiency to infrared; asynchronized seed source may be derived from the driving laser or be a different laser. The coupling of the input pulses with the Raman-active medium in a Raman-active medium-filled hollow waveguide is optimized using an input power control and a spatial coupling module. The interaction of the input pulses with the Raman-active medium in the waveguide results as output in anti-Stokes and Stokes pulses along with spectrally broadened input pulses.

A method according to an embodiment of an aspect of the present invention generating frequency-shifted output using a pulsed driving laser and a Raman-active medium-filled hollow waveguide, for stimulated Raman scattering (SRS).

Optical parametric amplification (OPA) may be used for amplification of the generated frequency-shifted components and for generating CEP stable seed pulses from the pulsed driving laser; amplification depends on the available pump energy and generated Stokes or anti-Stokes energy. The wavelength of the generated Stokes and anti-Stokes pulses depends upon the input laser wavelength and the Raman shift produced by the Raman active medium. The photon-conversion-efficiency (pump to first Stokes) is up to 40%. The post-HCF photon conversion efficiency of the generated Stokes beam is up to 50% for multi-stage OPA.

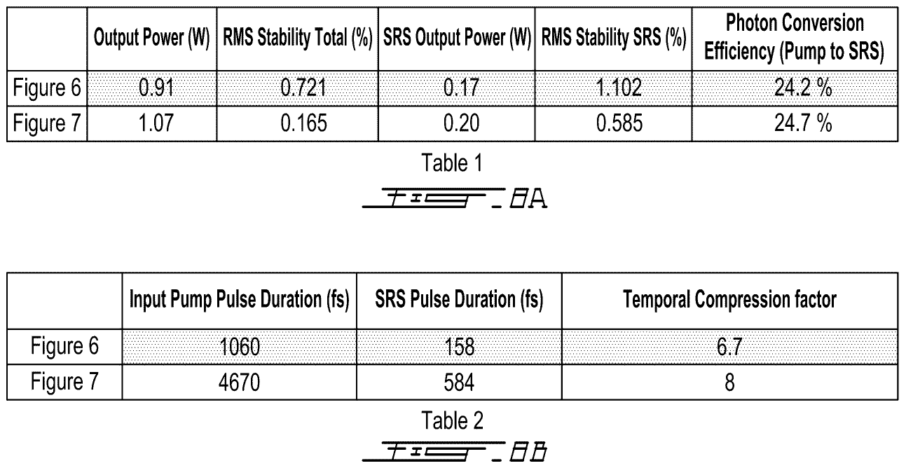

Optical parametric generation (OPG) may be used for generating seed pulses using a pulsed laser, along with the driving laser. The generated wavelength depends on the nonlinear crystal used for OPG and the wavelength of the driving laser. Typical energy up to 0.1 microjoules (Table 1 FIG. 8A).

Difference frequency generation (DFG) may be used for generating CEP stable idler pulses by nonlinear mixing of the driving and frequency-shifted Stokes output and for generating CEP stable seed pulses using a pulsed laser as input, along with the driving laser. The generated wavelength depends on the wavelength of the driving laser and of the Stokes pulses used for nonlinear mixing in a crystal.

Supercontinuum generation may be used for generating seed pulses using a pulsed laser, along with the driving laser. Typical energy is up to 0.5 microjoules.

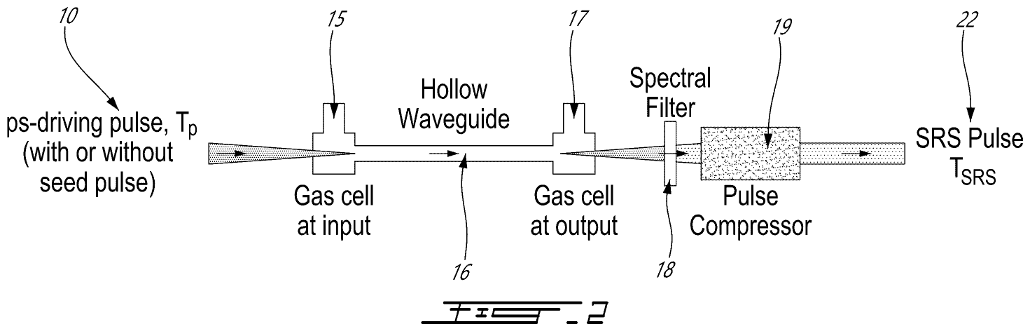

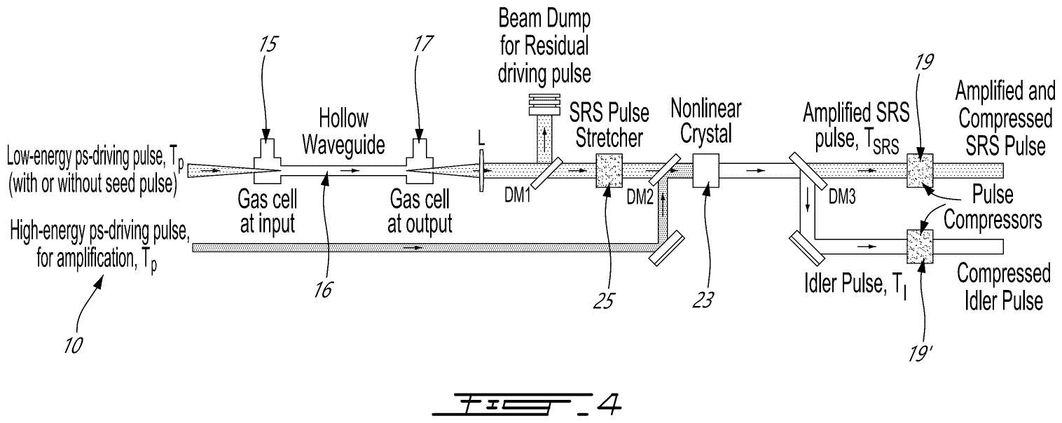

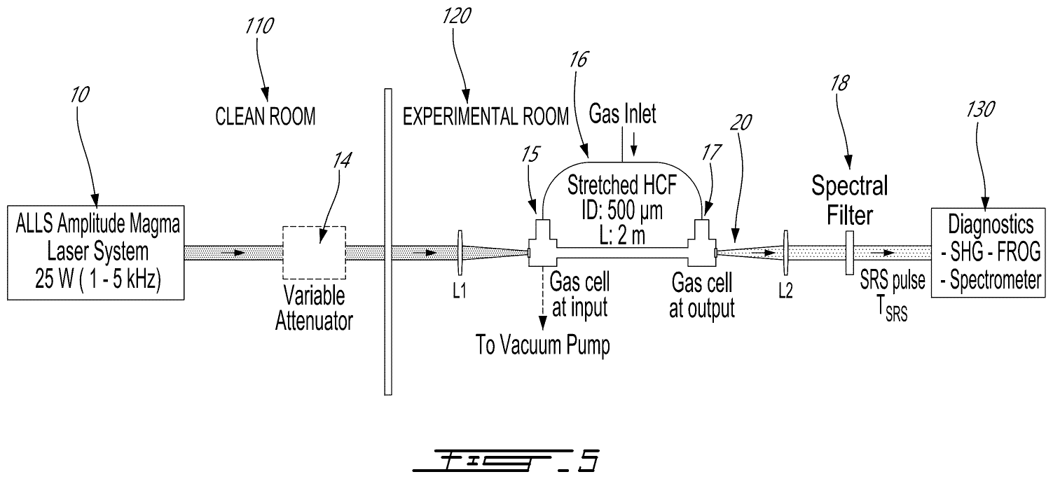

FIG. 1 shows a driving laser 10, emitting an input pulse Tᵢₙ of a duration selected according to the dephasing time (T₂) of the vibrational coherence in the nonlinear medium, which depends on the pressure of the nonlinear medium. For example, for methane at a pressure of 2 bars, the input pulse duration Tᵢₙ is selected between 300 fs and 30 ps. The pulse can be Fourier-transform limited or chirped. The input pulse Tᵢₙ drives the SRS in the gas-filled hollow waveguide 18. A low-energy part of the pulsed driving laser 10 may be used to generate the seed pulses via optical parametric processes and supercontinuum generation. Alternatively, a seed pulse laser source 12, continuous wave or pulsed laser source, temporally synchronized with the driving laser 10, may be used, selected with a central wavelength centered around the wavelength of the Stokes or anti-Stokes pulses to be amplified. The input power control 14 may be a variable attenuator comprising a half-waveplate and a polarizer selected according to the central wavelength of the driving laser 10 to control the input pulse energy in the hollow waveguide 18. The spatial coupling module 16 comprises focusing optics, such as coupling lens L1 in FIG. 5, or mirrors, selected to mode-match the coupling of the input pulse and the seed pulses in the hollow waveguide 16. The hollow waveguide 16 may be selected among fibers and Raman cells, filled either with Raman-active gas or a mixture of Raman active gases or even a Raman active liquid an optical filter 18 may be used to spectrally filter a target output 22 wavelength. Spectral filters (18 FIGS. 2, 3 and 5), dichroic mirrors (DM FIG. 4), or beamsplitters may be used to filter the SRS output.

FIG. 2 shows a high-Raman scattering cross-section medium filled hollow-waveguide frequency shifter and pulse compression system (ps-driving pulse duration T_{P}, with or without seed pulse; SRS pulse referred to hereinafter as Stokes pulse duration T_{SRS}) according to an embodiment of an aspect of the present disclosure. The HCF 16 may be filled with a Raman active gas under static pressure or may have a pressure gradient by pumping one of the gas cells 15, 17. The pressure gradient may also be created by filling the fiber 16 laterally and maintaining vacuum or low pressure at the input and output gas cells 15, 17, using a vacuum pump as shown for example in FIG. 5. The interaction of driving pulses with the gas results in the generation of SRS output, which can be spectrally filtered using the spectral filter 18. Furthermore, by means of dispersion compensation, the SRS output can be temporally compressed using a pulse compressor 19.

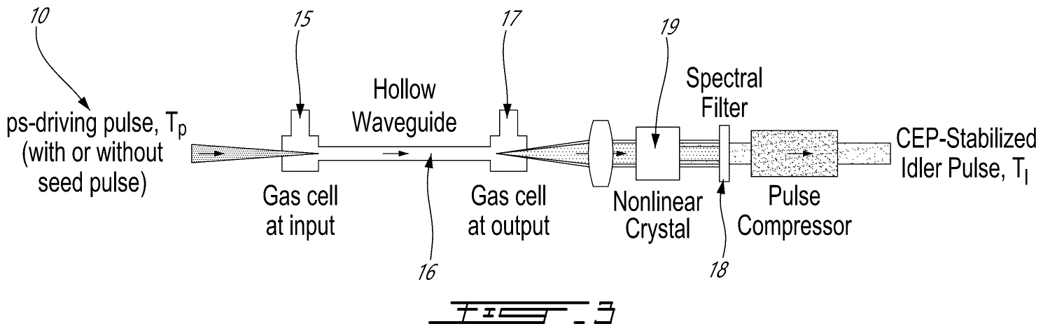

FIG. 3 is a schematical view of an optical parametric chirped pulse amplification (OPCPA) system, based on a high-Raman scattering cross-section filled hollow-waveguide frequency shifter and pulse compression system. It shows an inline setup to generate a CEP-stabilized idler pulse (ps-driving pulse duration T_{P}, with or without seed pulse; CEP-stabilized idler pulse duration T_{I}) according to an embodiment of an aspect of the present disclosure. At the HCF 16 output, the residual driving pulses and the generated SRS pulses can be used as pump and seed pulses for nonlinear frequency mixing in a selected nonlinear crystal 21 to generate passively CEP-stable idler pulses. The generated idler pulses can then be spectrally filtered from the driving pump and SRS pulses using spectral filter 18.

FIG. 4 is a schematical view of a system for generating CEP stabilized idler pulses. It shows an optical parametric chirped pulse amplifiers (OPCPA) system based on the high-Raman scattering cross-section filled hollow-waveguide frequency shifter and pulse compression system according to an embodiment of an aspect of the present disclosure, using a low-energy part of the ps-driving pulse Tp, with or without seed pulse, and a high-energy part of the ps-driving pulse Tp for amplification. At HCF 16 output, the generated SRS pulses can be used as seed pulses for an OPCPA. First, the generated SRS pulses (seed pulses) can be temporally stretched to a duration same as that of the driving pulses using a stretcher 25. These temporally stretched seed pulses can be parametrically amplified in a selected nonlinear crystal 23. During the amplification, idler pulses of pulse duration T_{I} are also generated. The amplified SRS pulses of pulse duration T_{SRS} and generated idler pulses of pulse duration T_{I} can be temporally compressed by dispersion compensation using dichroic mirror DM3 to compressors 19, 19′.

In experiments performed using a system according to an embodiment of an aspect of the present disclosure illustrated in FIG. 5, the driving laser 10 was a 25 W amplitude magma laser system (1-5 kHz) (Advanced Laser Light Source (ALLS), clean room 110, experimental room 120). The input pulse at 1030 nm and 1 kHz repetition rate was coupled into a 2 m hollow-core fiber 16 of inner diameter of 500 μm, using lens L1 (f=+750 mm). The pulse duration of the input pulses was varied between 900 fs and 5 ps by changing the separation between gratings. The HCF 16 was maintained under a static pressure of methane gas fed through a gas inlet 15 using a vacuum pump. The HCF 16 output 20 was collimated using lens L2 (f=+1500 mm). Both residual pump and SRS pulses were characterized using second harmonic generation-frequency resolved optical gating (SHG-FROG) 130.

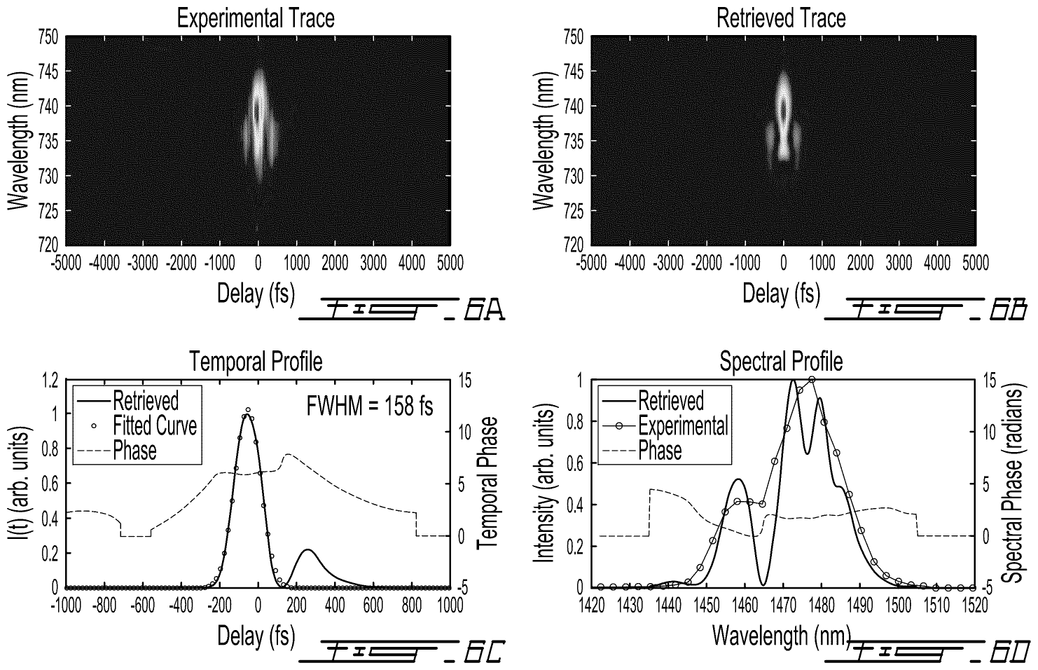

Experimental results of the characterization of the NIR SRS pulse (input—1.06 ps, 1030 nm, 2 W (2 mJ/pulse at 1 KHz), where the HCF was maintained at a static CH₄ pressure of 2 bars, and at the HCF output, SRS pulses were spectrally filtered from the residual input pulses using spectral filter FELH1300 (Thorlabs, inc.) and characterized using SHG-FROG, are shown in FIG. 6.

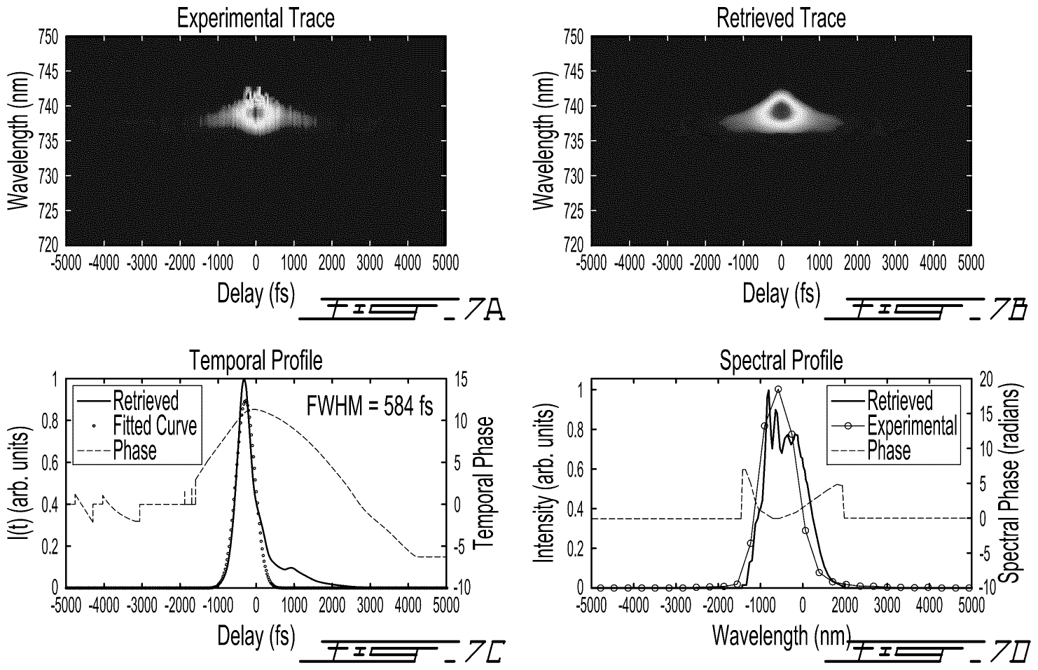

Experimental results of the characterization of near infrared NIR SRS pulse (input: 4.7 ps, 1030 nm, 2 W (2 mJ/pulse at 1 KHz)), where the HCF was maintained at a static methane pressure of 2 bars, and at the HCF output, SRS pulses were spectrally filtered from the residual input pulses using spectral filter FELH1300 (Thorlabs, inc.) and characterized using second-harmonic generation-FROG (SHG-FROG), are shown in FIG. 7.

Tables 1 and 2 in FIGS. 8A and 8B respectively summarize the results of FIGS. 6 and 7.

The presently disclosed method and system for the generation of ultrashort light pulses, in the range of sub-picosecond and even shorter, across the electromagnetic spectrum, ranging from the ultraviolet to the far infrared spectral range, proved to be robust, safe, and cost-efficient.

The presently disclosed method and system use gases with a high Raman-scattering cross-section, such as for example methane CH₄ and CD₄ in hollow waveguides or gas cells, to produce ultrashort pulses with picosecond driving pulses. The duration of the driving pulses is selected to be lower than the dephasing time of the vibrational mode of the gases.

The use of such high Raman-scattering cross-section gases provides energy conversion efficiency and temporal compression factors matching those of multistage optical parametric chirped pulse amplifiers (OPCPA) systems, at much lower and thus safer gas pressures, typically under 6 atm, as demonstrated hereinabove using hollow-core fibers. The conversion efficiency from input to red-shifted pulses is higher. The residual input pulses at the output of the waveguide and the generated stokes pulse can be mixed to obtain passively CEP-stabilized ultrashort pulses. Spectral tunability is achieved by selecting the gas according to the vibrational Raman shift it produces. The method may be used for amplification and compression of seed sources. Using a CEP-stabilized seed source, the method allows for the generation and amplification of ultrashort CEP-stabilized pulses.

Hollow waveguides filled with Raman active gas may be replaced by any Raman active medium such as a waveguide or cell filled with Raman active liquid for example.

The presently disclosed method and system use gases with high Raman scattering cross-sections in any type of hollow waveguides or gas cells o produce ultrashort light sources (see FIG. 2), significantly reducing the experimental complexities associated with the current state-of-the-art technologies, such as operating hollow waveguides or Raman cells under very high gas pressure, where typically multistage amplification is needed to produce a few 100s-microjoules NIR pulses, and the need for multistage CEP stabilization.

The presently disclosed method and system provide a single-stage pathway for building compact, single-stage, cost-effective, and safer systems for laser sources operating in different regions of the electromagnetic spectrum.

Using a CEP-stabilized seed source, the method allows for the generation and amplification of ultrashort CEP-stabilized pulse (see for example FIG. 3). The nonlinear mixing of residual pump pulses and generated Stokes beam provides a robust inline technique to produce CEP stable pulses. Amplification and compression of external seed sources, with the capability of maintaining CEP stability.

There is thus provided a method and a system for generating frequency-shifted ultrashort pulses with duration shorter than the input pulses.

Ultrashort light sources generated due to red shifting of the central wavelength of input sub- to multi-picosecond (ps) laser pulses in any Raman active medium are disclosed. The red-shifted pulses can be temporally few-hundreds of fs long and are generated by exploiting the χ (3) nonlinearity of gases with a high-Raman scattering cross-section in a hollow waveguide such as hollow core fiber and hollow-core photonic crystal fiber for example. The interplay of self-phase modulation (SPM), cross-phase modulation (XPM), and vibrational stimulated Raman scattering (SRS) results in the generation of a red-shifted and temporally compressed output with a few hundred microjoules of pulse energy.

There is thus presented a cost-efficient, safe, and practical solution for generating ultrashort light sources based on driving pulses of sub- to multi-ps durations. Moreover, passively carrier-envelope phase (CEP) stabilized pulses can be generated in an inline system and method, as opposed to the use of multistep nonlinear systems and methods. The method may provide passively CEP-stabilized idler pulses in an inline configuration by nonlinearly mixing residual driving pulses and the red-shifted SRS pulses obtained at the output of the hollow waveguide.

The presently disclosed method and system may be used for the optical synchronization of the Ti:Sa and Yb:YAG laser technologies. A part of a Ti:Sa amplifier output at 800 nm can be shifted to 1030 nm to provide a high energy seed for a Yb:YAG multipass amplifier, resulting in hundreds of mJ level laser output at 1030 nm.

The presently disclosed method and system may generate UV-visible ultrashort pulses of energy levels up to a few tens of microjoules.

Seeding a hollow waveguide with very low energy pulses at the Stokes wavelength produces frequency-shifted compressed pulses with higher quantum efficiency, significantly reducing the length of the waveguide. In addition, the pulse-to-pulse stability is improved.

The scope of the claims should not be limited by the embodiments set forth in the examples but should be given the broadest interpretation consistent with the description as a whole.

1. A system for making ultrashort light sources, comprising:
a pulsed driving laser,
a nonlinear medium;
a hollow waveguide filed with the nonlinear medium;
an input power control selected according to a central wavelength of the driving laser to control an input pulse energy from the driving laser in the hollow waveguide,
wherein:
a duration of the input pulse of the driving laser is selected according to a dephasing time of a molecular vibration of the nonlinear medium, the input pulse driving vibrational stimulated Raman Scattering in the nonlinear medium-filled hollow waveguide; interaction of the input pulses with the nonlinear medium in the hollow waveguide resulting as output in anti-Stokes and Stokes pulses.

2. The system of claim 1, comprising an optical filter selected to spectrally filter a target output wavelength.

3. The system of claim 1, wherein a low-energy part of the driving laser is used to generate seed pulses, the system comprising a spatial coupling module selected to mode-match coupling in the hollow waveguide between the input pulse and seed pulses.

4. The system of claim 1, further comprising a synchronized seed pulse laser selected with a central wavelength centered depending on a wavelength of the Stokes or anti-stokes pulses to be amplified to generate the seed pulses, and a spatial coupling module selected to mode-match coupling in the hollow waveguide between the input pulse and seed pulses.

5. The system of claim 1, wherein the input power control comprises a half-waveplate and a polarizer selected according to the central wavelength of the driving laser.

6. The system of claim 1, wherein a low-energy part of the driving laser is used to generate seed pulses, the system comprising a spatial coupling module selected to mode-match coupling in the hollow waveguide between the input pulse and seed pulses, the spatial coupling module comprises one of coupling lenses and mirrors.

7. The system of claim 1, further comprising a synchronized seed pulse laser selected with a central wavelength centered depending on a wavelength of the Stokes or anti-stokes pulses to be amplified to generate the seed pulses, and a spatial coupling module selected to mode-match coupling in the hollow waveguide between the input pulse and seed pulses, the seed pulse laser being one of pulsed and continuous.

8. The system of claim 1, further comprising a synchronized seed pulse laser selected with a central wavelength centered depending on a wavelength of the Stokes or anti-stokes pulses to be amplified to generate the seed pulses, and a spatial coupling module selected to mode-match coupling in the hollow waveguide between the input pulse and seed pulses, the spatial coupling module comprises one of coupling lenses and mirrors.

9. The system of claim 1, wherein the hollow waveguide is one of: hollow-core fibers and Raman cells.

10. The system of claim 1, wherein the nonlinear medium is a Raman-active medium.

11. The system of claim 1, wherein the nonlinear medium is one of: Raman-active gases and Raman-active liquids.

12. The system of claim 1, wherein the optical filter is one of: spectral filters, dichroic mirrors and beamsplitters.

13. A method, comprising passing an input pulse from a pulsed driving laser into a Raman-active medium-filled hollow waveguide to generate frequency-shifted Stokes output by stimulated Raman scattering; resulting in frequency-shifted Stokes output pulses of a wavelength depending upon a wavelength of the driving laser and a Raman shift produced by the Raman-active medium.

14. The method of claim 13, spectrally filtering a target output wavelength.

15. The method of claim 13, comprising amplification of the generated frequency-shifted output by optical parametric amplification.

16. The method of claim 13, comprising generating seed pulses using a seed pulse laser synchronized with the driving laser.

17. The method of claim 13, comprising generating seed pulses using a low-energy part of the driving laser.

18. The method of claim 13, comprising generating CEP stable idler pulses by difference frequency generation by nonlinear mixing of the input pulse and the frequency-shifted Stokes output.

19. The method of claim 13, comprising generating CEP-stabilized idler pulses using residual input pulse and the frequency-shifted Stokes output as pump and seed pulses for nonlinear frequency mixing in a selected nonlinear crystal, and spectrally filtering generated CEP-stabilized idler pulses.

20. The method of claim 13, comprising generating CEP stabilized idler pulses using a low-energy part of the input pulse, and a high-energy part of the input pulse for amplification, the frequency-shifted Stokes output of being used as seed pulses for optical parametric chirped pulse amplification in a selected nonlinear crystal.
